(19) United States
(12) Patent Application Publication
(10) Pub. No.: US 2015/0029941 A1
(43) Pub. Date: Jan. 29, 2015

(54) Public Services Access Point (PSAP) Designation of Preferred Emergency Call Routing Method Via Internet or Public Switched Telephone Network (PSTN)

(71) Applicant: TeleCommunication Systems, Inc., Annapolis, MD (US)

(72) Inventors: Richard Dickinson, Seattle, WA (US); John Gordon Hines, Kirkland, WA (US); Jonathan Croy, Seattle, WA (US)

(21) Appl. No.: 14/513,917

(22) Filed: Oct. 14, 2014

Related U.S. Application Data
(63) Continuation of application No. 11/475,220, filed on Jun. 27, 2006.
Application No. 11/475,220 is a continuation-in-part of application No. 12/929,992, filed on Mar. 1, 2011, now Pat. No. 8,873,718.
Application No. 12/929,992 is a continuation of application No. 11/150,343, filed on Jun. 13, 2005, now Pat. No. 7,903,791.
Application No. 11/150,343 is a continuation of application No. 10/739,292, filed on Dec. 19, 2003, now Pat. No. 6,940,950.

(51) Int. Cl. H04W 4/22; H04L 29/06

(52) U.S. Cl. CPC H04W 4/22; H04L 65/1046; H04L 65/1069
USPC 370/328

(57) ABSTRACT

The use of the VoIP emergency network for routing wireless E911 calls to a designated PSAP. In this embodiment, a mobile positioning center (MPC) assigns an ESRK per existing prior art, but uses the invention to route the call to the PSAP via the VoIP server and an ESGW. This relieves wireless carriers of the obligation to install and maintain expensive dedicated SS7 or CAMA trunks from each MSC to each selective router in the areas served by that MSC. Instead, wireless 911 calls can be consolidated by ESGW vendors, maximizing the efficiency of the dedicated trunks to the selective router by sharing those trunks with multiple MSCs.

### BACKGROUND OF THE INVENTION

1. Field of the Invention

This invention relates generally to E9-1-1 emergency phone calls. More particularly, it relates to emergency E9-1-1 calls using Voice Over Internet Protocol (VoIP), originating from wireless networks.

2. Background of the Related Art

911 is a phone number widely recognized as an emergency phone number that is used to contact a Public Safety Answering Point (PSAP), where call takers dispatch emergency personnel to the victim. Enhanced 911 (E911) is defined by the digital transmission of callback number and location information to the relevant (PSAP). E911 may be implemented for landline and/or mobile devices. Some Public Safety Access Points (PSAPs) are not enhanced, and thus do not receive the callback or location information from any phone, landline or mobile.

Many cars built today include a telematics system. The word “telematics”, in its broadest sense, relates to the combination of computers and wireless telecommunications technologies. More recently, the term “telematics” has evolved to refer to automobile systems that combine global positioning satellite (GPS) tracking and other wireless communications for automatic roadside assistance and remote diagnostics. General Motors Corp. first popularized automotive telematics with its OnStar™ system. Mercedes-Benz offers a similar system called TeleAid™. The use of the word “telematics” throughout the current specification is intended to refer to the later definition of more recent recognition, i.e., to mean automotive telematics.

Many new vehicles are equipped with wireless-based telematics units providing services controlled by voice commands. One successful telematics system is available from OnStar Corp. (www.onstar.com). According to OnStar, OnStar brings together emergency service providers, wireless telephone, and satellite technologies to help protect a driver, and keep them connected on the road.

As part of the telematics system, a telematics unit including a cellular circuit is located within the vehicle, and powered by the vehicle's battery. Telematics units were originally analog-only, but have migrated to analog/digital-ready, and finally to dual-mode analog/digital. Dual-mode analog/digital telematics units operate on both the analog and digital wireless networks.

With a suitable subscription to use of a telematics operations center such as OnStar, a driver or passenger in a vehicle including a telematics unit has access to a voice-activated calling feature in their vehicle, just in case their hand-held cell phone is lost, forgotten or has a low battery. They can pre-purchase OnStar Hands-Free Calling minutes to use on the road. Such packages are typically billed to a credit card they keep on file with OnStar. They can order minutes packages by pushing the phone or white-dot button at any time.

Conventional telematics units are also capable of providing location information to a requesting wireless network, using a Global Positioning Satellite (GPS) mounted in the vehicle, or using other location technology within the wireless network. When a vehicle occupant pushes a given button in the vehicle, essentially calling the telematics operations center, the telematics operations center identifies the vehicle's location. Moreover, if their air bag deploys, the location of the vehicle can be reported to the telematics operations center. So it's only when the button is pushed to contact the telematics operations center, or when the telematics operations center is responding to an emergency signal, that the telematics operations center is provided with a location of the vehicle.

Today, most telematics companies and more generally alarm companies monitor signals from customers' car, home or business. The monitoring is usually centralized in a single location for customer locations across the country (e.g., a station in Columbus, Ohio might monitor homes throughout the country for a given monitoring company. In more global companies, an alarm or other monitoring company might monitor alarm signals from homes in the United States from a centralized command center located in Bombay, India.

Thus, in today's global economy, when a customer places an emergency call such as a 911 call (or automated alarm system emergency call), the call may be routed very far away, and in some instances half-way across the world. The telematics operator must then transfer the 911 call to the relevant 911 center (public safety access point (PSAP)). However, this transfer must take place over the Public Switched Telephone Network (PSTN) because such transfer, cannot conventionally be gained to the PSAP's existing Enhanced 911 (E911) dedicated network where location and callback number of the originating 911 caller are provided. Moreover, note that even the call related information (e.g., CallerID) provided with the call would relate to the identity and location of the centralized telematics center—not to the callback number and certainly not the location of the customer originally dialing 911.

FIG. 5 shows conventional relevant systems in an emergency 911 call made via a telematics call center.

In particular, as shown in FIG. 5, a telematics unit 101 within a car dials 911. The 911 call is serviced by a cell site of a service provider, which includes a given mobile servicing center (MSC) 102. The MSC 102 passes the 911 call on to its relevant telematics call center 104. The telematics call center 104 may be, e.g., an ONSTAR™ call center.

The operator at the telematics call center 104 that handles the 911 call of its own subscriber obtains the identity and location information of the 911 caller. Based on the current location of the 911 caller, the operator performs a query of a telematics PSAP database 106 to determine a unique 10-digit phone number of the proper local PSAP physically responsible for the location of the 911 caller. The telematics PSAP database 106 is preferably essentially the equivalent of an Emergency Routing Data Base (ERDB).

The operator at the telematics call center 104 then forwards the 911 caller to the PSAP by dialing its 10-digit phone number via the public switched telephone network (PSTN) 110.

Unfortunately, calls that arrive at the PSAP in this manner do not include call-back number (Automatic Number Identification (ANI)) and location information (Automatic Location Identification (ALI)). Moreover, the PSTN telephone 302 at the PSAP 118 is typically not answered with the same priority as are calls that originate on its E911 network. In addition, these calls are typically not recorded or time-stamped by PSAP equipment as are calls that arrive via the E911 network.

Trials have been conducted in which a local exchange carrier (LEC) has permitted access to a selective router for the E911 network via the PSTN. In this trial, the LEC designated a specific 10-digit telephone number. A caller has their emergency call transferred to this 10-digit telephone number, which is then call-forwarded within the central office to the selective router, which then forwards the call to the correct PSAP based upon the digits dialed. However, this solution suffers the same significant drawbacks as that shown in FIG. 3, i.e., that callback number and location are not provided to the responsible PSAP.

Other conventional technology relies on the PSAP having separate, second set of phone equipment capable of receiving proprietary data from the telematics center 104. But this solution would be prohibitively costly to implement nationwide for each telematics center, not to mention take up valuable space inside a PSAP center. Thus, the costs and disruption caused by the need for new hardware has little congestion control, making this a rather undesirable solution.

There is the need for a simple and effective solution to providing easy and full access to the Enhanced 911 network of an emergency services provider (e.g., PSAP) from users of a centralized call center, e.g, telematics call center, alarm call center, etc.

### SUMMARY OF THE INVENTION

In accordance with the principles of the present invention, a method and apparatus for providing a wireless mobile switching center (MSC) with access to an Enhanced 911 network supporting a public safety answering point (PSAP), comprises egressing a wireless 911 call to a voice over Internet protocol (VoIP) call server. An emergency services routing key (ESRK) is provided to the VoIP call server. The ESRK is used to determine a selective router trunk. The wireless 911 call is converted from Internet protocol (IP) to a switched network protocol. The wireless 911 call is routed through a selective router in the Enhanced 911 network.

### BRIEF DESCRIPTION OF THE DRAWINGS

FIG. 1 shows an exemplary E911 architecture including E911 network access provided to a telematics call center or other call center, in accordance with the principles of the present invention.

FIG. 2 shows an exemplary call flow tracing an emergency 911 call from a telematics subscriber source to the appropriate PSAP, in accordance with the principles of the present invention.

FIG. 3 shows the use of an ESRK to route an emergency services 911 call to an appropriate designated public services answer point (PSAP) via a VoIP call server and an emergency services gateway, in accordance with the principles of the present invention.

FIG. 4 shows another embodiment of the invention in which a wireless MSC may bypass the PSTN by incorporating session Internet protocol (SIP) functionality into a wireless MSC with SIP capability, in accordance with the principles of the present invention.

FIG. 5 shows conventional relevant systems in an emergency 911 call made via a telematics call center.

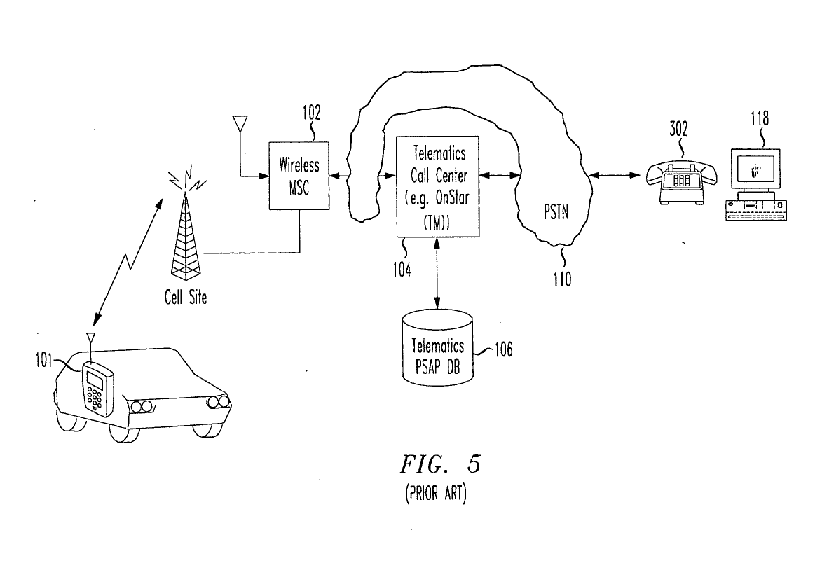

### DETAILED DESCRIPTION OF ILLUSTRATIVE EMBODIMENTS

In a first embodiment, an emergency call (e.g., 911 call, alarm company call) forwarded by a telematics call center is routed over the switched PSTN to a Voice Over Internet Protocol (VoIP) call server, where the switched call is converted to a packetized IP call for presentation to an emergency services gateway (ESGW) which in turn routes the call to a selective router, gaining access to the Enhanced 911 network. Call routing information is provided using a VoIP positioning center (VPC), which determines the appropriate ESGW and assigns a related Emergency Services Query Key (ESQK).

In a later embodiment, the VoIP network of ESGWs and VPC is used to route wireless emergency services routing keys (ESRKs) to an enhanced E911 network of a public service access point (PSAP) using packetized VoIP data.

Voice Over IP (VoIP) is a technology that has been developed as an alternative telephony technology to the conventional telephony service (e.g. PSTN). VoIP takes advantage of high speed Internet data packet networks, and is able to provide low cost telephony services to end users. VoIP technology emulates a phone call, but instead of using a circuit based system such as the telephone network, utilizes packetized data transmission techniques most notably implemented in the Internet.

Voice-Over-Internet Protocol (VoIP) emulates a phone call, but instead of using a circuit based system such as the telephone network, utilizes packetized data transmission techniques most notably implemented in the Internet.

VoIP phone calls are routed to a VoIP call server, from which they are passed on to their destination VoIP device. Conventional VoIP call servers (i.e., soft switches) are typically located in only a few places across the country. A soft switch is a programmable network switch that can process the signaling for all types of packet protocols. Softswitches can support, e.g., IP, DSL, ATM and frame relay. In many cases, VoIP calls must interface with traditional TDM calls. This is accomplished via media gateways (protocol converters) that integrate SS7 telephone signaling with packet networks.

Because VoIP is Internet Protocol (IP) based, call related information such as CallerID type services may not be available or accurate. This is particularly true of caller location data during emergency calls.

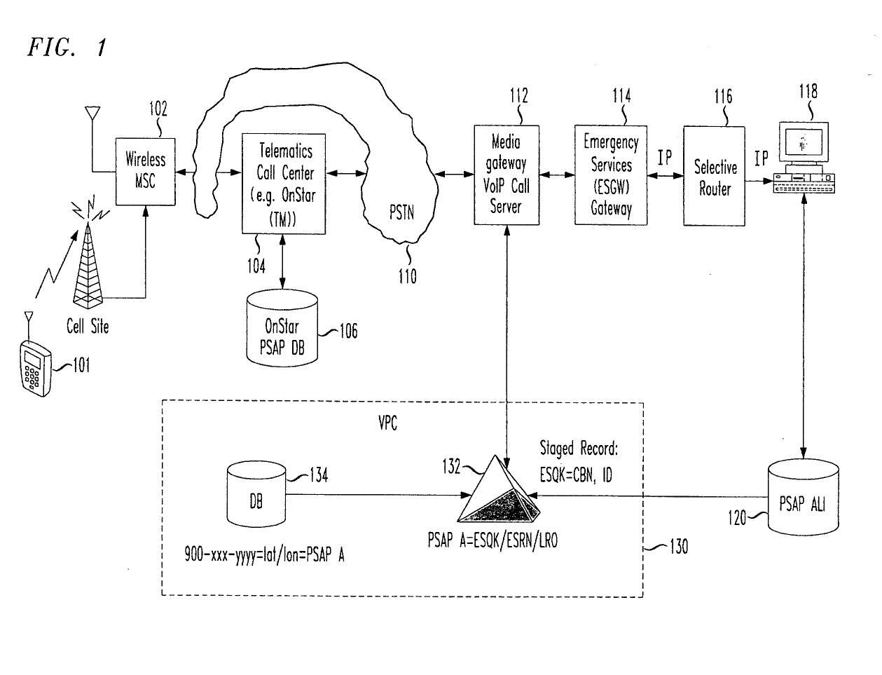

FIG. 1 shows an exemplary E911 architecture including E911 network access provided to a telematics call center or other call center, in accordance with the principles of the present invention.

The present invention applies VoIP technology in lieu of the switched telephone connectivity of the PSTN to route calls to a media gateway/VoIP call server 112. The switched call is converted into a packetized call using Internet Protocol (IP), and is routed via the Internet to the ESGW 114 closest to the appropriate selective router for the destination PSAP. The ESGW converts the packetized IP data back into traditional TDM, and routes the call to the intended selective router 116 via dedicated TDM trunks, where it enters the E911 network. A selective router is the node in an emergency services network that performs enhanced call routing for 911 calls.

An example will be used to further illustrate the inventive architecture. In this example, a telematics unit 101 within a car dials 911. The 911 call is serviced by a cell site of a service provider, which includes a given mobile servicing center (MSC) 102. The MSC 102 forwards the 911 call on to its relevant telematics call center 104 via the PSTN. The telematics call center 104 may be, e.g., an ONSTAR™ call center, and may be located anywhere in the country or anywhere in the world.

The operator at the telematics call center 104 that handles the 911 call of its own subscriber obtains the nature of the call, as well as the identity and location of the 911 caller. The identity and location of the 911 call from the subscriber is most often received by the call center 104 over the open phone line to their subscriber. Equipment to receive the exact location of the subscriber is expensive, but necessary only at the centralized telematics call center. The thousands of PSAPs in the country do not have the same equipment, as it would be prohibitively expensive.

Based on the current location of the 911 caller, the operator performs a query of a telematics PSAP database 106 to determine a local PSAP physically responsible for that location, as well as a unique 10-digit phone number to access the Enhanced 911 network of that PSAP.

The operator at the telematics call center 104 handling the 911 call forwards the emergency call to a given media gateway/VoIP call server 112 by dialing the designated 10-digit number for that PSAP

To determine the appropriate PSAP and ESGW, the VoIP call server 112 queries a VoIP positioning center (VPC) 130. Using the 10-digit phone number dialed by the call center operator 104, the VPC queries the database 134 to determine the corresponding PSAP. The VPC then assigns an Emergency Services Query Key (ESQK) to the call and relays this routing key back to the VoIP Call Server 112.

The VoIP call server 112 passes the 911 emergency call on to an emergency service gateway (ESGW) 114, which in turn passes the 911 emergency call on to the desired PSAP 118. An ESGW resides in a VoIP service provider's network, and is responsible for integrating the session initiation protocol (SIP) network with the emergency services network (TDM). An ESGW 114 network includes dedicated voice trunks to selective routers in the Enhanced 911 (E911) network for any/all PSAPs being served (ideally a national network). The ESGW 114 routes 911 calls to the appropriate selective router, based on the ESRN/ESQK it receives.

The selective router 116 is provisioned with emergency services query keys (ESQKs) with ALI steering. (The ESQK is a digit string that uniquely identifies an ongoing emergency services call and is used to correlate the emergency services call with the associated data messages. It may also identify an emergency services zone and may be used to route the call through the network. The ESQK is similar to an ESRK in wireless E911 networks.)

A subscriber location database (SLDB) 134 is also provisioned. Preferably the SLDB 134 is configured so that no modifications are required to the core conventional existing VoIP E9-1-1 network. The SLDB 134 is used to relate a Session Initiation Protocol (SIP) Universal Resource Identifier (URI) or a telephone number to a PSAP.

In the given embodiments the SLDB 134 includes a listing of a series of “subscribers”, in which each subscriber is really a specific PSAP with a designated 1-900-xxx-yyyy phone number. Note that the phone number does not need to be a 1-900 number as this is used as an example only. This is also a useful technique for billing the call center for this service.

In the disclosed embodiments, the address of this “subscriber” is the latitude/longitude (lat/lon) of a centroid of the jurisdiction of the relevant PSAP. Alternatively, in databases that use tables in lieu of GIS for routing determination, the address of the “subscriber” can be any valid address within the jurisdiction of the PSAP.

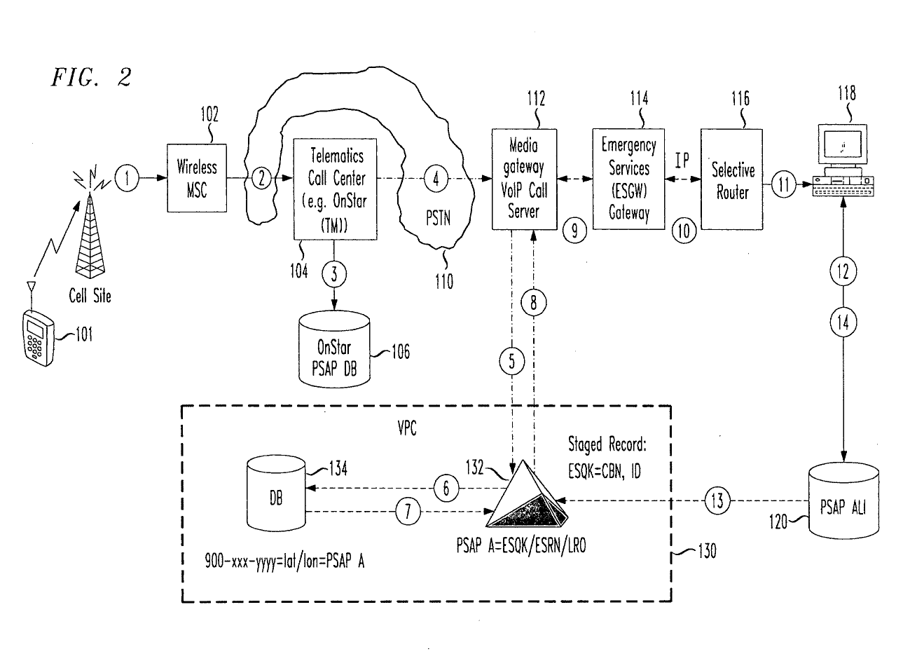

FIG. 2 shows an exemplary call flow tracing an emergency 911 call from a telematics subscriber source to the appropriate PSAP, in accordance with the principles of the present invention.

In particular, as shown in FIG. 2, a caller or automated calling device 101 contacts a local security monitoring company or roadside assistance operator or similar third party call center 104. As an example shown in step 1, a caller 101 dials 911, which is serviced through a wireless MSC 102 and passed on to the relevant telematics call center, e.g., an OnSTAR™ call center. In the given example, the wireless MSC 102 may be part of a wireless carrier's network, with the 911 call being forwarded to the relevant telematics call center 104. Alternatively, the MSC 102 may be part of a large wireless network used by the telematics company itself.

The 911 call may be placed using an SOS or similar single-press button located in a car for use in emergency situations, automatically in the event of an accident, etc. Alternatively, the phone user may simply dial 911 in a manual cell phone call from a mobile phone, either integrated into a vehicle or entirely separate from a vehicle.

In step 2, a wireless MSC 102 routes the incoming emergency call to a telematics call center 104 (e.g., an ONSTAR™ or TeleAid™ call center). In the given example this routing includes use of the PSTN 110, though this need not be the case in all applications.

The call taker at the call center 104 who receives the 911 call from the caller 101 determines that this is an emergency call that must be referred to the local 911 PSAP.

Thus, in step 3, the telematics call taker queries an existing telematics PSAP database 106 to determine the correct PSAP to which the call should be routed. Of course, to save time step 3 may be performed simultaneous with, or even prior to, the call taker's determination that the call from the mobile user 101 is an emergency call.

In step 4, a telematics dispatcher dials (could be the same person and/or equipment as the call taker) a NPA-xxx-yyyy number designated for the determined PSAP. For instance, the call taker at the call center 104 then dials 1-900-xxx-yyyy, a designated number for that PSAP 118, and prepares to conduct a conference call with the caller 101 and the PSAP 118.

The call is then routed, via the PSTN 110, to a designated VoIP call server 112 (alternatively referred to as a media gateway). The media gateway and the VoIP call server may be two distinct functions co-located in the same unit, as in the present embodiment. The media gateway converts TDM to IP. The VoIP call server routes the resulting IP calls much like a traditional telephone switch routes a TDM call.

The VoIP call server 112 receives the ANI (caller ID) of the call center. The VoIP media gateway 112 reformats the call from time division multiplex (TDM) or code division multiplexed (CDM) into session initiation protocol (SIP). The VoIP Call Server rearranges the dialed digits, putting the DID that was dialed in step iii (e.g., 1-900-xxx-yyyy) in the FROM field and putting the ANI of the call center into the Just-in-Time callback number (JIT CBN) field within the P-Asserted Identity in the SIP Invite. (Session initiation protocol (SIP) is an IP-based protocol defined in IETF RFCs 3261 and 2543, the entirety of which are expressly incorporated herein by reference. SIP is one of two dominant messaging protocols used by the VoIP industry.

Importantly, the VoIP Media Gateway/call server 112 converts the TDM or CDM protocol of the incoming switched network phone call to packet data using session initiation protocol (SIP), and vice versa, meaning that packetized VoIP information coming from a relevant PSAP is converted into a switched connection with the 911 caller, terminated at the VoIP call server 112.

In step 5, the VoIP call server 112 forwards the 911 call to the VPC 130 as a VoIP call. The Invite is received by the VPC 130 for call routing instructions.

The VPC 130 is an application that determines the appropriate PSAP, based on the location of the 911 caller 101, returns associated routing instructions to the VoIP network, and provides the call center's identity and the callback number to the PSAP through the automatic location identification (ALI). (An ALI is a database that relates a specific telephone number to an address. This database accepts a PSAP query with a telephone number and responds with an address. In the case of an ESQK, the ALI database steers (redirects) the query to the appropriate VoIP positioning center and steers the response back to the querying PSAP).

A SIP Invite command may be used for the query from the Call Server 112 to the VPC 130. The disclosed SIP Invite command preferably includes the following parameters:
a) The “from” field
   =the dialed digits from the call center (NPA-xxx-yyyy)
b) The “to” field
   =911
c) The JIT CBN field
   =callback number of the call center

In step 6, the VoIP positioning center 132 queries an ERDB (SLDB) 134 for call routing instructions based upon the dialed NPA-xxx-yyyy number. The ERDB 134 relates the dialed number to the address of that phone number (lat/lon of the PSAP jurisdictional centroid) and determines the appropriate PSAP to receive the call. Within the ERDB 134, each phone number corresponds to a different PSAP.

In step 7, the ERDB 134 responds to the VPC 130 with the identity of the appropriate PSAP to serve the caller 101. The VPC 130 assigns an ESQK and emergency services routing number (ESRN) to the call and stages an ALI record. The ESRN is a 10-digit number that specifies the selective router to be used to route a call. The ALI record contains the phone number of the call center 104, based upon the ANI that accompanied the call. If the call center 104 is capable of sending the ANI of the actual end user, then this can be staged in the VPC ALI record.

Further call processing is otherwise per the conventional NENA i2 VoIP standard:

For instance, in step 8, the VoIP positioning center 130 assigns an emergency services query key (ESQK) appropriate to that PSAP, and stages a record with the call center call back number (CBN) and call center company ID.

The VoIP positioning center 130 responds to the VoIP call server 112 with the ESQK, emergency services routing number (ESRN), and last routing option (LRO). (The LRO is routing information sent by the VPC 130 that provides a “last chance” destination for a call, for example the contingency routing number (CRN) or a routing number associated with a national call center.

In step 9, the VoIP call server 112 uses the ESRN to route the call to the correct emergency services gateway (ESGW) 114.

The VoIP call server 112 uses the received ESRN to determine the appropriate ESGW 114 and routes the call appropriately to the correct emergency services gateway (ESGW) 114. The ESGW 114 uses the ESRN to determine the appropriate selective router 116. For simplicity and clarity of description, only one ESGW 114 and one selective router 116 are pictured in FIG. 2.

In step 10, the ESGW 114 performs media conversion by converting the SIP protocol (and vice versa in the opposite communication direction), and uses the ESRN to route the call to the correct selective router 116, along with the ESQK.

In step 11, the selective router 116 routes the ESQK to the PSAP 118.

In step 12, the PSAP 118 queries the automatic location identification (ALI) database 120 using the ESQK.

In step 13, the ALI database 120 steers the query to the VoIP positioning center (VPC) 130, per previously provisioned steering tables. The VPC 130 responds with a staged record that includes the callback number (CBN) and call center company ID. In the preferred embodiments, no latitude/longitude (lat/lon) is sent in the ALI record, although such data could be forwarded if it is available.

In step 14, the ALI database 120 forwards the callback number (CBN) and call center ID to the requesting PSAP 118.

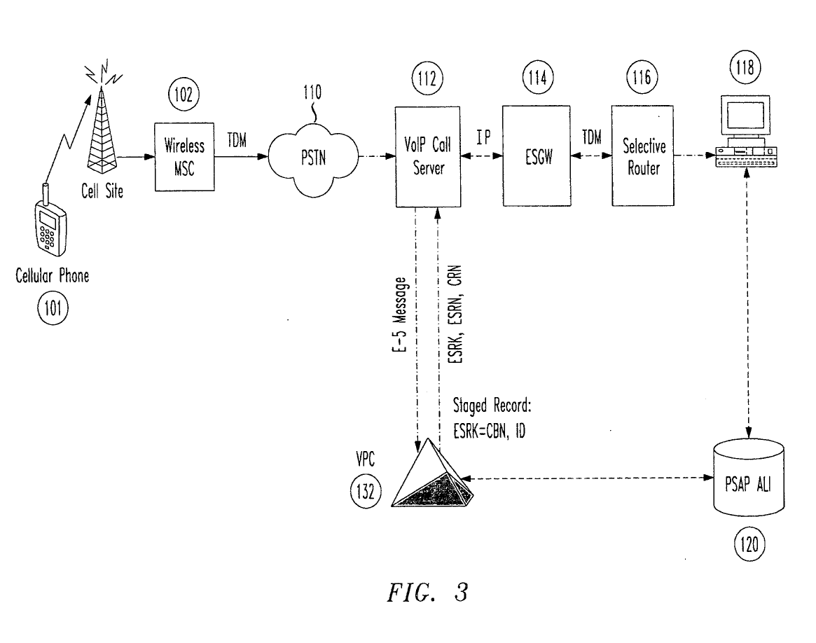

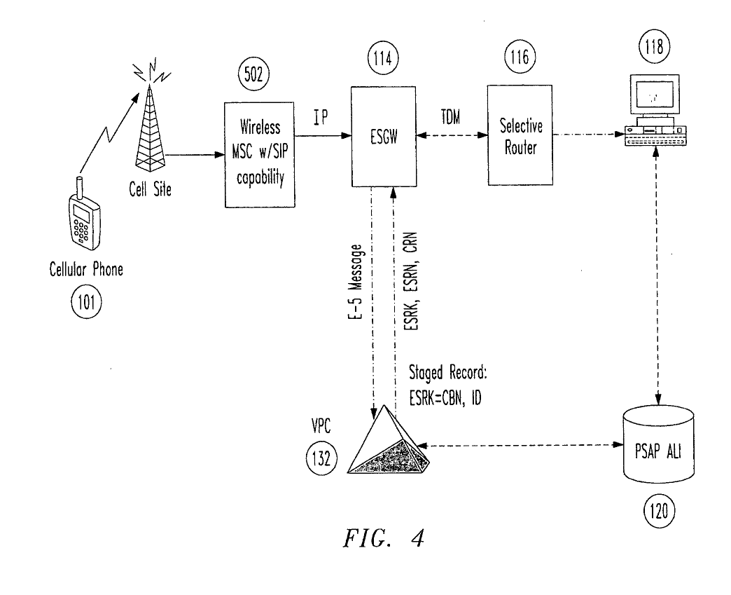

The embodiments of FIGS. 3 and 4 show the use of a VoIP emergency network for routing wireless E911 calls to a designated PSAP. In these embodiments, a mobile positioning center (MPC) assigns an ESRK per existing prior art, but uses the invention to route an emergency call to a designated PSAP via a VoIP call server and an ESGW.

FIG. 3 shows the use of an ESRK to route an emergency services 911 call to an appropriate designated public services answer point (PSAP) via a VoIP call server 112 and an emergency services gateway (ESGW) 114, in accordance with the principles of the present invention.

In particular, as shown in FIG. 3, in the case of a wireless call emanating from a wireless device 101, a wireless 911 call is received by a wireless MSC 102. The wireless MSC 102 egresses all 911 calls to a designated 10-digit number, dialed via the PSTN 110. The wireless 911 call is terminated at the VoIP call server 112.

The VoIP call server 112 queries a voice positioning center (VPC) 132 for routing instructions, using existing E5 message formatting as described in standard J-Std 036. The VPC 132 extracts location information in the E5 message, then uses this location information, plus existing functionality traditional to wireless MPCs, to determine the appropriately designated PSAP 118 to receive the 911 call.

Importantly, the VPC 132 assigns an ESRK, ESRN and CRN, and responds with this information to the VoIP Call Server 112. The VPC 132 also stages a record in a database that correlates the ESRK with the caller's phone number and location.

The VoIP call server 112 uses the ESRN to determine the appropriate ESGW 114 and routes the 911 call accordingly.

The ESGW 114 uses the ESRK to determine the correct selective router trunk and converts the call from IP protocol to SS7 or CAMA TDM protocol. The ESGW 114 then routes the call accordingly.

The remaining portion of the 911 call routing process is performed in accordance with existing art. For instance, the selective router 116 uses the ESRK to determine the appropriately designated PSAP 118 and routes the 911 call accordingly.

The PSAP 118 queries the automatic location identification (ALI) database 120 for caller ALI data. The ALI database 120, recognizing the ESRK, steers the query to the VPC 132, which responds with the previously staged record. The ALI database 120 or the wireless MPC 102 assigns a class of service (COS) to the call based upon the ESRK.

FIG. 4 shows another embodiment of the invention in which a wireless MSC 102 may bypass the PSTN by incorporating session Internet protocol (SIP) functionality into a wireless MSC 502 with SIP capability.

In particular, as shown in FIG. 4, E5 data is transmitted directly via Internet protocol (IP) to the VPC 132.

The embodiments of FIGS. 3 and 4 relieve wireless carriers of the obligation to install and maintain expensive dedicated SS7 or CAMA trunks from each MSC to each selective router in the areas served by that MSC. Thus, wireless carriers are provided with cost-saving options to eschew dedicated circuits from their own MSCs to local selective routers in favor of emergency call routing via the voice over Internet protocol (VoIP) network. Instead, wireless 911 calls can be consolidated by ESGW vendors, maximizing the efficiency of the dedicated trunks to the selective router by sharing those trunks with multiple MSCs.

While the invention has been described with reference to the exemplary embodiments thereof, those skilled in the art will be able to make various modifications to the described embodiments of the invention without departing from the true spirit and scope of the invention.

1. A method of providing a wireless mobile switching center (MSC) with access to an Enhanced 911 network supporting a public safety answering point (PSAP), comprising:
receiving a circuit-switched 911 call associated with a wireless phone device at a voice over Internet protocol (VoIP) call server;
converting, at said voice over Internet protocol VoIP) call server, said circuit-switched 911 call to an Internet Protocol (IP) 911 call;
associating a particular emergency services routing key (ESRK), received from a positioning center, with said circuit-switched-to-IP converted call and a specific Public Safety Access Point (PSAP); and
transmitting, via an appropriate selective router selected according to said ESRK, said circuit-switched-to-IP converted 911 call from said VoIP call server to said specific PSAP.

2. The method of providing a wireless mobile switching center (MSC) with access to an Enhanced 911 network supporting a public safety answering point (PSAP) according to claim 1, further comprising:
querying, from said VoIP call server, a voice positioning center (VPC) for said routing key.

3. The method of providing a wireless mobile switching center (MSC) with access to an Enhanced 911 network supporting a public safety answering point (PSAP) according to claim 1, wherein:
said circuit-switched 911 call is communicated via a circuit-switched network protocol comprising is signaling system No. 7 (SS7).

4. The method of providing a wireless mobile switching center (MSC) with access to an Enhanced 911 network supporting a public safety answering point (PSAP) according to claim 1, wherein:
said circuit-switched 911 call is communicated via a circuit-switched network protocol comprising Centralized Automatic Message Accounting (CAMA) time division multiplex (TDM) protocol.

5. The method of providing a wireless mobile switching center (MSC) with access to an Enhanced 911 network supporting a public safety answering point (PSAP) according to claim 1, further comprising:
egressing said switched 911 call to said VoIP call server via the public circuit-switched telephone network (PSTN).

6. The method of providing a wireless mobile switching center (MSC) with access to an Enhanced 911 network supporting a public safety answering point (PSAP) according to claim 1, further comprising:
extracting location information in an E5 formatted message.

7. The method of providing a wireless mobile switching center (MSC) with access to an Enhanced 911 network supporting a public safety answering point (PSAP) according to claim 1, wherein:
said IP wireless 911 call is egressed to a VoIP emergency services gateway using session Internet protocol (SIP) signaling.

8. Apparatus for providing a wireless mobile switching center (MSC) with access to an Enhanced 911 network supporting a public safety answering point (PSAP), comprising:
means for receiving a circuit-switched 911 call associated with a wireless phone device at a voice over Internet protocol (VoIP) call server;
means for converting, at said voice over Internet protocol (VoIP) call server, said circuit-switched 911 call to an Internet Protocol (IP) 911 call;
means for associating a particular emergency services routing key (ESRK), received from a positioning center, with said circuit-switched-to-IP converted call and a specific Public Safety Access Point (PSAP); and
means for transmitting, via an appropriate selective router selected according to said ESRK, said circuit-switched-to-IP converted 911 call from said VoIP call server to said specific PSAP.

9. The apparatus for providing a wireless mobile switching center (MSC) with access to an Enhanced 911 network supporting a public safety answering point (PSAP) according to claim 8, further comprising:
means for querying, from said VoIP call server, a voice positioning center (VPC) for said routing key.

10. The apparatus for providing a wireless mobile switching center (MSC) with access to an Enhanced 911 network supporting a public safety answering point (PSAP) according to claim 8, wherein:
said circuit-switched 911 call is communicated via a circuit-switched network protocol comprising is signaling system No. 7 (SS7).

11. The apparatus for providing a wireless mobile switching center (MSC) with access to an Enhanced 911 network supporting a public safety answering point (PSAP) according to claim 8, wherein:
said circuit-switched 911 call is communicated via a circuit-switched network protocol comprising Centralized Automatic Message Accounting (CAMA) time divisional multiplex (TDM) protocol.

12. The apparatus for providing a wireless mobile switching center (MSC) with access to an Enhanced 911 network supporting a public safety answering point (PSAP) according to claim 8, further comprising:
means for egressing said circuit-switched 911 call to said VoIP call server via the public switched telephone network (PSTN).

13. The apparatus for providing a wireless mobile switching center (MSC) with access to an Enhanced 911 network supporting a public safety answering point (PSAP) according to claim 8, further comprising:
means for extracting location information in an E5 formatted message.

14. The apparatus for providing a wireless mobile switching center (MSC) with access to an Enhanced 911 network supporting a public safety answering point (PSAP) according to claim 8, further comprising:
means for egressing said IP 911 call to said VoIP call server using session Internet protocol (SIP) signaling.
